(19) United States
(12) Patent Application Publication
(10) Pub. No.: US 2011/0231859 A1
(43) Pub. Date: Sep. 22, 2011

(54) PROCESS ASSIGNING DEVICE, PROCESS ASSIGNING METHOD, AND COMPUTER PROGRAM

(75) Inventors: Eiji HASEGAWA, Kawasaki (JP); Toru Kamiwada, Kawasaki (JP)

(73) Assignee: FUJITSU LIMITED, Kawasaki (JP)

(21) Appl. No.: 13/042,782

(22) Filed: Mar. 8, 2011

(30) Foreign Application Priority Data
Mar. 19, 2010 (JP) 2010-64926

(51) Int. Cl. G06F 9/46

(52) U.S. Cl. 718/104

(57) ABSTRACT

A process assigning device includes executing an operation including receiving an assignment request including device identification information, content and process identification information, determining whether identification of another device exists on the basis of the content identification information indicated by the received assignment request, storing the device identification information included in the assignment request in association with the content identification information and the process identification information, and the process identification information in association with the device identification information when determining that the identification of the other device does not exist. When the processor determines the identification information of the other device exists, the processor causes the device identification information included in the assignment request, and the assigned part information indicating the part that is included in the content data and that varies by device identification information to be stored.

### CROSS-REFERENCE TO RELATED APPLICATIONS

This application is based upon and claims the benefit of priority of the prior Japanese Patent Application No. 2010-64926, filed on Mar. 19, 2010, the entire contents of which are incorporated herein by reference.

### FIELD

Various embodiments described herein relate to a process assigning device, a process assigning method and a computer program, which allow a plurality of data processing devices to interoperate to perform a process.

### BACKGROUND

An accumulating device may accumulate content data delivered through the Internet or the like and perform various types of processes on the accumulated content data. For example, there is a data converting device that has a function of converting a video stream content recorded from television broadcast into a video stream data for a mobile phone device. In addition, there is a data converting device that has a function of analyzing a content, automatically adding chapters to the content to edit the content easily. Furthermore, there is a data converting device that has a function of improving the quality of a low-resolution video.

Workloads of the data converting devices that perform the aforementioned processes are heavy, and the processes cannot be performed at a higher speed than the original bit rate of the content in many cases. For example, when a process of playing video of the content and a process of converting the content into data in another format are simultaneously performed, it is necessary to simultaneously decode multiple data pieces and re-encode the data pieces, so workload of a data processing device becomes heavy.

By installing dedicated hardware such as a decoder in the data processing device, the aforementioned problem can be solved to an extent. When the device is distributed, and a new format or a method for using the device is then developed after the distribution, it becomes difficult to deal with the problem using the hardware. When a process using software can be performed, it is possible to deal with the problem by generally updating the software and thereby adding a function. However, when a decoding process and a content process are performed using software, a workload that is applied to a data processing device becomes heavy. Unless such a problem is solved, it is difficult to provide a function by using software.

It can be considered that a broadcast server delivers a converted content. However, in a method in which a server device performs a process of converting a content and a process of delivering the converted content, when multiple types of conversion processes are to be performed, it is necessary that the server device prepare all data of the content. Therefore, a delivery load of the server device becomes large.

WO2006/025322 generally discusses a method for performing a content process at a high speed by causing a plurality of devices to interoperate to jointly perform the content process. According to WO2006/025322, a data processing device searches whether or not another device that can process a content exists in a network. When the device exists, the data processing device transmits a part of the content to the other device and assigns the part of the content to the other device so that the other device processes the part of the content. For example, the content is divided into three parts: first to third parts. The first part is assigned to and processed by a data converting device. The second part is assigned to and processed by a personal computer (PC), and the third part is assigned to and processed by a game machine. As a result, a size of the content part that is processed by the data processing device is approximately a third of the original size of the content, and a content process can be performed at a higher speed.

### SUMMARY

According to an embodiment, a process assigning device includes a storage unit that stores content identification information identifying content data, process identification information identifying the detail of a process of processing the content data, device identification information identifying a data processing device that processes the content data, assigned part information indicating a part that is included in the content data and assigned to and processed by the data processing device.

A process assigning device receives an assignment request from the data processing device, and the assignment request includes the device identification information, the content identification information and the process identification information. A process assigning device checks whether the content identification information and the process identification information indicated by the received assignment request exists in the process assignment tables in the storage unit which stores assigned part information for each contents and processes. If another data processing device which processes the same content and same process exists, a process assigning device assigns different part of the content for processing to each data processing devices.

When the process assigning device checks the assignment request, and another data processing device which processes the same content and same process indicated by the assignment request does not exist in the process assignment tables, which indicate the device and assignment list for processing same content and same process, the process assigning device generates the process assignment table which stores device identification information, content identification information and the process identification information included in the assignment request. When the process assigning device checks the assignment request, and another data processing device which processes the same content and same process indicated by the assignment request exists, the processor assigns part information for each data processing devices, and the processor transmits the assigned part information to the data processing device identified by the device identification information stored in the storage unit. Also process assigning device stores assigned part information as the process assignment table in the storage unit.

Objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a schematic diagram illustrating a configuration of a process assigning system according to an embodiment;

FIG. 2 is a block diagram illustrating an internal configuration of a data processing device;

FIG. 3 is an outline diagram illustrating an example of an assignment request that is transmitted by a data processing device;

FIG. 4 is an outline diagram illustrating an example of a response that is returned by a server device;

FIG. 5 is a block diagram illustrating an internal configuration of a server device;

FIG. 6 is an outline diagram illustrating an example of a process assignment table;

FIG. 7 is a flowchart of a process that is performed when a data processing device requests an assignment;

FIG. 8 is a flowchart of a content process that is performed by a data processing device;

FIG. 9 is a flowchart of a process that is performed when a request to transmit partial data is received from another device;

FIG. 10 is a flowchart of a process that is performed by a server device;

FIG. 11 is a schematic diagram explaining operational timings of each of devices;

FIG. 12 is a schematic diagram explaining operational timings of each of devices according to an embodiment;

FIG. 13 is a schematic explaining operational timings of each of devices according to an embodiment;

FIG. 14 is a schematic explaining operational timings of each of devices according to an embodiment;

FIG. 15 is a block diagram illustrating an internal configuration of a data processing device that has a function of managing a license;

FIG. 16 is a block diagram illustrating an internal configuration of a server device that has a function of managing a license;

FIG. 17 is a block diagram illustrating a configuration of a system;

FIG. 18 is a flowchart of a process that is performed by a server device;

FIG. 19 is a diagram illustrating another example of a process assignment table.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

A process can be jointly performed by an unlimited number of calculating devices for a reduced time. However, when another device uses a process resource that is not necessary for the other device, there is no advantage for a user of the other device. Thus, a problem arises including when a content process is jointly performed using a device owned by another user.

There is a technique in which when a certain device confirms whether or not multiple devices can perform a process and requests the multiple devices to perform the process and another device actually performs the process, an advantage is provided to the device that performs the process by making payment with electronic money.

In the technique, a compensation for provision of a process resource is paid, and unfairness is generally corrected. However, when a plurality of devices simultaneously provide requests to another device, the device that performs a content process may immediately become saturated.

By managing data processing devices that try to perform the same process on a certain content and assigning parts of the process to the data processing devices, it is possible to correct unfairness and prevent the devices that jointly perform the process from being saturated.

A process assigning device disclosed in the embodiments includes a receiving unit, an assignment control unit and a storage unit. The receiving unit receives an assignment request from a data processing device that performs a process on a part or all of content data. The assignment request includes the content identification information and the process identification information to be processed, and the device identification information declares the data processing device. The assignment request also means that is a request to transmit assigned part information on a part that is included in the content data and assigned to and processed by the data processing device. The assignment control unit determines partial data to be assigned to and processed by the data processing device on the basis of the assignment request received by the receiving unit and transmits information on the assigned partial data to the data processing device. The storage unit stores the transmitted assigned part information, while the assigned part information is associated with the information that identifies the data processing device that is a destination of the assigned part information.

The assignment control unit includes a determining unit, a first assigning unit, a second assigning unit and an updating unit. The determining unit determines, on the basis of the information stored in the storage unit, whether or not another data processing device to which data to be processed is already assigned for the content data that is to be processed and is indicated by the assignment request received by the receiving unit exists. When the determining unit determines that the other data processing device to process the same content and the same process does not exist, the first assigning unit assigns data to be processed to the data processing device that has transmitted the assignment request so that the data processing device that has transmitted the assignment request processes a part or all of the content data. When the determining unit determines that the other data processing device to process the same content and the same process exists, the second assigning unit assigns data to be processed to the data processing devices so that the data processing device that has transmitted the assignment request processes a part of the content data and that the other processing device processes another part of the content data. The updating unit updates the information stored in the storage unit on the basis of the results of the assignments performed by the second assigning unit.

It is possible to improve the efficiency of a process by assigning parts of the process to data processing devices that try to perform the process so that all the data processing devices jointly perform the process and obtain an advantage.

The embodiments are described with reference to the accompanying drawings.

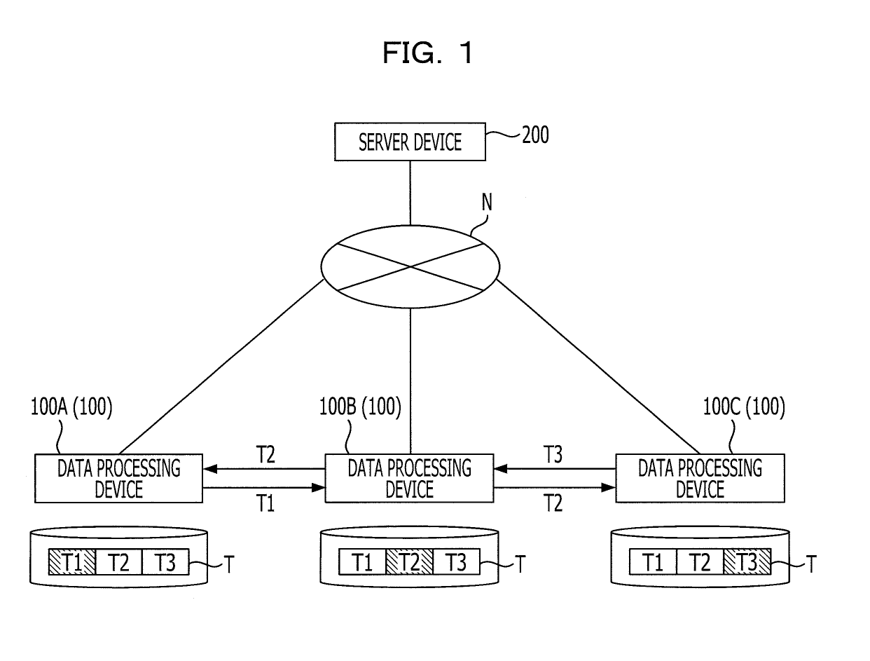

FIG. 1 is a schematic diagram illustrating a configuration of a process assigning system according to an embodiment. The process assigning system according to an embodiment includes data processing devices 100A, 100B and 100C (100A to 100C) and a process assigning device 200. The data processing devices 100A to 100C each process a part or all of content data. The process assigning device 200 manages assignments of parts of a process to the data processing devices 100A to 100C. The data processing devices 100A to 100C and the process assigning device 200 are connected to each other through a network N.

In the following description, when it is not necessary to distinguish the data processing devices 100A to 100C, the data processing devices 100A to 100C are indicated by data processing devices 100.

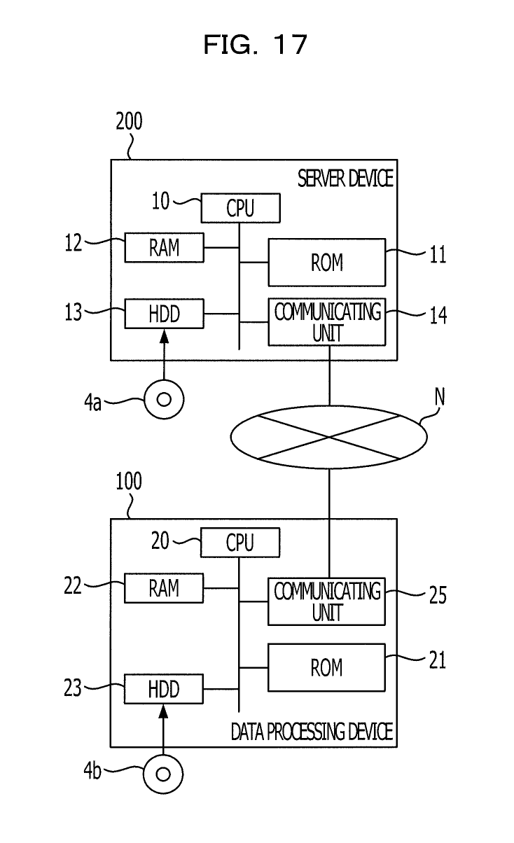

FIG. 17 is a block diagram illustrating a system, according to an embodiment.

The process assigning device 200 includes hardware parts that are a central processing unit (CPU) 10, a read only memory (ROM) 11, a random access memory (RAM) 12, a hard disk drive (HDD) 13, a communicating unit 14 and the like. The hardware parts are connected to each other through a bus.

The CPU 10 reads a program stored in the HDD 13 into the RAM 12 and executes the program. The CPU 10 controls operation(s) of the aforementioned hardware parts. The ROM 11 includes a flash memory, serves as a ROM, and stores a program that is called a BIOS and executed at the time of initial startup of the server device. The RAM 12 is a storage device that is accessed for a short time. The RAM 12 is a static RAM (SRAM), a dynamic RAM (DRAM) or the like, for example. The RAM 12 temporarily stores the program that is executed by the CPU 10. In addition, the RAM 12 temporarily stores various types of data that is generated at the time of execution of the program.

The HDD 13 is a large-capacity storage device. A storage device called a solid state drive (SSD) may be used as the HDD 13. The HDD means an auxiliary storage device that includes an SSD for a descriptive purpose. The HDD 13 stores a process assignment program, data tables and the like. The data tables are used for processes. The programs are each read by the CPU 10 into the RAM 12 and executed by the CPU 10. The programs are installed in the HDD 13 through an external medium such as a compact disc-ROM (CD-ROM) 4a. The programs may be downloaded through the network and installed in the HDD 13.

The data processing devices 100 each include hardware parts that are a CPU 20, a ROM 21, a RAM 22, a HDD 23, a communicating unit 25 and the like. The hardware parts are connected to each other through a bus. The communicating unit 25 is connected to the network N and communicates with the other devices that are connected to the network N.

The CPU 20 reads a program stored in the HDD 23 into the RAM 22 and executes the program. The CPU 20 controls operations of the aforementioned hardware parts. The ROM 21 includes a flash memory, serves as a ROM, and stores a program that is called a BIOS and executed at the time of initial startup of the data processing device. The RAM 22 is an SRAM, a DRAM, a flash memory or the like. The RAM 22 temporarily stores the program that is executed by the CPU 20. In addition, the RAM 12 temporarily stores various types of data that is generated at the time of execution of the program.

The HDD 23 is a large-capacity storage device. A storage device called a solid state drive (SSD) may be used as the HDD 23. The HDD means an auxiliary storage device that includes an SSD for a descriptive purpose. The HDD 23 stores a content process program, a content combination program, various types of data and the like. The programs are installed in the HDD 23 through an external medium such as a CD-ROM 4b. The programs may be downloaded from the network and installed in the HDD 23.

In order for each of the data processing devices 100 to process a content, the data processing device 100 notifies the process assigning device 200 of detail(s) of the process to be performed, a target to be processed and various types of parameters, and requests the process assigning device 200 to assign data to be processed to the data processing device 100 so that the data processing device 100 processes the assigned data. The process relative to content data that is performed by the data processing devices 100 is not limited to any particular processes and may include a conversion process, an image processing, a modeling process, an analysis process and the like. As the conversion process, there may be a process that is performed to change the format (encoding format) of content data, for example. As the image processing, there is a process that is performed to increase a resolution of content data, for example. In addition, as the image processing, there is a process that is performed to improve the quality of content data, for example. As the modeling process, there is a modeling and rendering process that is performed to three-dimensionally display content data, for example. As the analysis process, there is a process that is performed to add, to content data, additional information such as context information, index information, tag information, chapter information and the like on the basis of the results of analysis of an video image, audio data, meta data and a time code, which are included in the content data, for example. In addition, the analysis process may be a process that is performed to output additional information generated as the results of processing content data.

When the process assigning device 200 receives the assignment requests from the data processing devices 100, the process assigning device 200 generates a list (device list) of the data processing devices 100 that have notifies the process assigning device 200 of the same process detail and the same data to be processed and have transmitted the assignment requests. The process assigning device 200 determines data to be assigned to and processed by the data processing devices 100 on the basis of the generated device list. The process assigning device 200 then notifies the data processing devices 100 of information (assigned part information) on the data assigned to the data processing devices 100.

The data processing devices 100 each process the data assigned to the data processing device 100 on the basis of the assigned part information transmitted by the process assigning device 200. In addition, the data processing device 100 transmits the processed partial data to the other data processing devices and receives the partial data processed by the other data processing devices. Then the data processing device 100 combines the partial data processed by the data processing device 100 with the partial data processed by the other data processing devices so as to form the processed data of the entire content.

In the example illustrated in FIG. 1, content data T is divided into three parts: partial data T1, T2 and T3; the data processing device 100A processes the partial data T1 that is a start portion of the content data T; the data processing device 100B processes the partial data T2 that is a middle portion of the content data T; and the data processing device 100C processes the partial data T3 that is an end portion of the content data T. The data processing device 100A transmits the partial data T1 processed by the data processing device 100A to the data processing device 100B and receives the partial data T2 processed by the data processing device 100B from the data processing device 100B. In the same manner, the data processing device 100B transmits the partial data T2 processed by the data processing device 100B to the data processing device 100C and receives the partial data T3 processed by the data processing device 100C from the data processing device 100C. The data processing device 100C transmits the partial data T3 processed by the data processing device 100C to the data processing device 100A and receives the partial data T1 processed by the data processing device 100A from the data processing device 100A, although these operations are not illustrated in FIG. 1.

In this manner, each of the data processing devices 100 does not process all the parts of the content data and can obtain the processed data of the entire content by processing only the partial data of the content. The data processing devices 100 each form the processed data of the entire content by combining the partial data of the entire content.

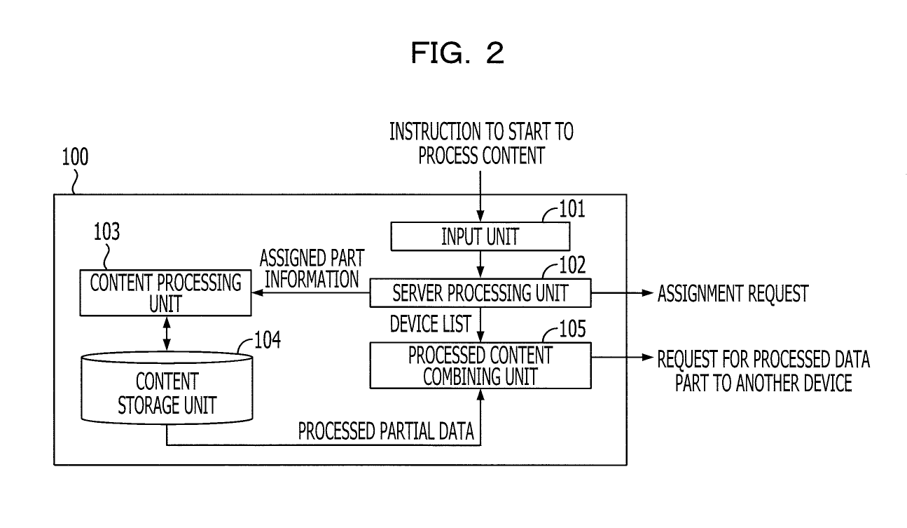

FIG. 2 is a block diagram illustrating an internal configuration of the data processing device 100. The data processing device 100 includes an input unit 101, a server processing unit 102, a content processing unit 103, a content storage unit 104 and a processed content combining unit 105.

The input unit 101 is an input interface that receives an operation instruction provided by a user. The data processing device 100 receives, through the input interface, content data to be processed and an instruction such as details of a process to be performed. The server processing unit 102 performs a process of transmitting an instruction to the content processing unit 103 on the basis of a request transmitted to the server device 200 and a response to the request. The content processing unit 103 performs a process of converting content data into data in another format on the basis of the instruction received from the server processing unit 102. The content storage unit 104 includes a storage medium (for example, a hard disk, a memory or the like) to store data such as a broadcast content. The processed content combining unit 105 requests the other data processing devices 100 to transmit processed partial content data and performs a process of combining the partial content data processed by the content processing unit 103 with the partial content data processed by the other data processing devices 100.

Next, operations that are performed in the content process performed by the data processing device 100 are described. First, the data processing device 100 receives an instruction to start the content process through the input unit 101. In this case, the instruction to start the content process may be received directly through the input unit 101. In addition, the data processing device 100 may be instructed to start the content process through an embedded scheduler, for example. While specific examples of operations are described herein, the present invention is not limited to a particular start or type of process. For example, an instruction to process any type of content may be triggered by various factors including but not limited to a time of day, subscription, type of device, etc.

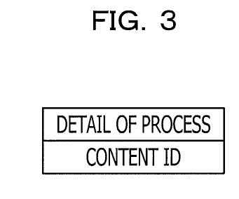

When the data processing device 100 receives the instruction to start the content process, the server processing unit 102 of the data processing device 100 request the process assigning device 200 to assign data to be processed to the data processing device 100. In this case, the server processing unit 102 transmits, to the process assigning device 200, an assignment request that includes a content ID and the detail of the content process. The content ID identifies the content. FIG. 3 is an outline diagram illustrating an example of the assignment request transmitted by the data processing device 100. The assignment request may include a time period for reproduction of the content, a conversion format, a bit rate, and additional information such as information on the throughput of the data processing device, as well as the aforementioned content ID and the detail of the content process.

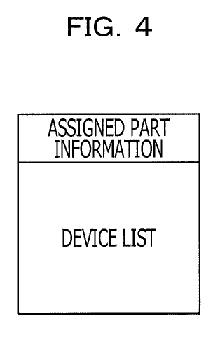

When the process assigning device 200 receives the assignment request from the data processing device 100, the process assigning device 200 groups (identify) devices that try to perform the same process on the same content, assigns data to be processed to the data processing device 100 that has transmitted the assignment request, and the process assigning device 200 returns a response after the assignment. FIG. 4 is an outline diagram illustrating an example of the response returned by the process assigning device 200. The response returned by the process assigning device 200 includes information (assigned part information) on the part assigned to the data processing device 100 and the list (device list) of the data processing devices 100 to which the process is assigned.

When the data processing device 100 receives the response from the process assigning device 200, the data processing device 100 notifies the processed content combining unit 105 of the device list included in the response, causes the content processing unit 103 to receive the assigned part information and instructs the content processing unit 103 to start the content process.

The content processing unit 103 performs the content process on the basis of the received assigned part information. The assigned part information may be any information as long as the assigned part information defines the part of the content data. For example, a time stamp in a Timestamped Transport Stream (TTS) file or the like can be used. The content processing unit 103 transmits the processed assigned partial data to the processed content combining unit 105.

The processed content combining unit 105 receives the processed partial data from the content processing unit 103 and other partial data that is included in the same content data and has been processed by the other the data processing devices 100. In this case, the processed content combining unit 105 transmits, to each of the other data processing devices 100 according to the device list, a request to transmit the partial data. The other data processing devices 100 are data processing devices other than the interested data processing device 100 and indicated in the device list. The request to transmit the partial data may be transmitted to a single data processing device 100. In addition, the request to transmit the partial data may be transmitted to a plurality of data processing devices 100.

In addition, when the processed content combining unit 105 receives the request to transmit the partial data from the other data processing devices 100, the processed content combining unit 105 transmits processed partial data that is indicated by the request. When the processed content combining unit 105 receives the processed partial data from the other data processing devices 100 in response to the request, the processed content combining unit 105 performs a process of combining the partial data processed by the interested data processing device 100 with the partial data received by the processed content combining unit 105 and processed by the other data processing devices 100.

In order to exchange the partial data as described above, information that is used to inspect all the partial data to be exchanged may be added to the data so that the data can be inspected. In addition, the data processing devices 100 may be configured so that each of all the data processing devices 100 transmits a certain amount of data to the other data processing devices and receives data from the other data processing devices and that a data processing device 100 that does not transmit data and receives data in order to exchange data with the other data processing devices 100 does not exist.

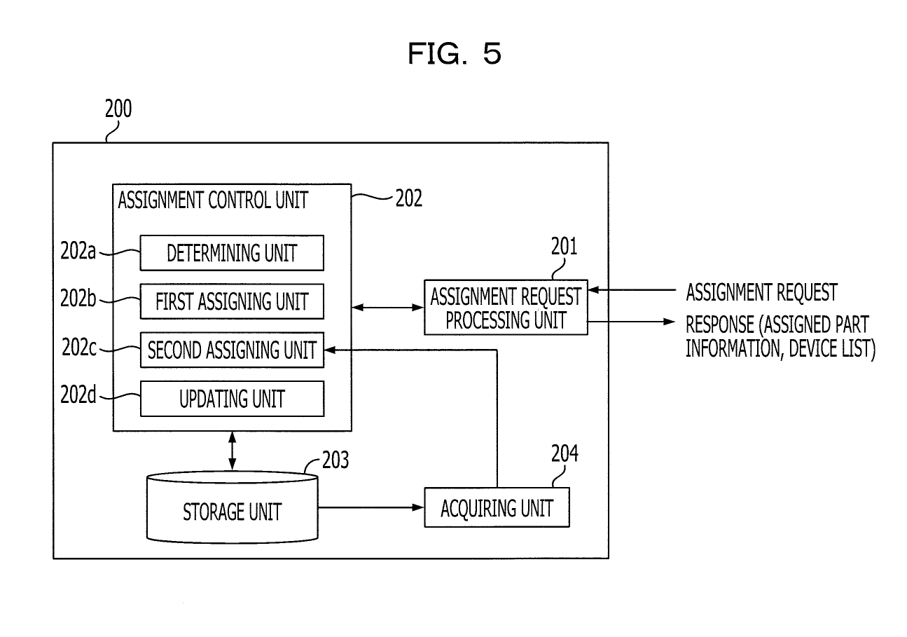

FIG. 5 is a block diagram illustrating an internal configuration of the process assigning device 200. The process assigning device 200 includes an assignment request processing unit 201, an assignment control unit 202 and a storage unit 203. The assignment control unit 202 includes a determining unit 202a, a first assigning unit 202b, a second assigning unit 202c and an updating unit 202d. The assignment control unit 202 is a processor or the like.

A computer program disclosed herein, for example, is stored in the storage unit 203. When the assignment control unit 202 executes the computer program, the process assigning device 200 functions as the process assigning device disclosed herein.

When the assignment request processing unit 201 receives the assignment request from the data processing device 100, the assignment request processing unit 201 transmits, on the basis of the assignment request, a response to the data processing device 100 that has transmitted the assignment request. In this case, a response includes assigned part information that is the result of assigning data to be processed. When the assignment control unit 202 receives the assignment request from the data processing device 100, the assignment control unit 202 determines data to be assigned to and processed by the data processing device 100 on the basis of information stored in the storage unit 203 and generates assigned part information and a list of devices to which the interested process is assigned. The assignment control unit 202 notifies the assignment request processing unit 201 of the generated assigned part information and the generated device list. Then, the assignment request processing unit 201 transmits the generated assigned part information and the generated device list to the data processing device 100 as a response to the assignment request.

The storage unit 203 includes a storage medium such as a hard disk, a memory or the like and stores information (process assignment table) on a list of devices to which data to be processed is assigned for each content data and each detail of the process.

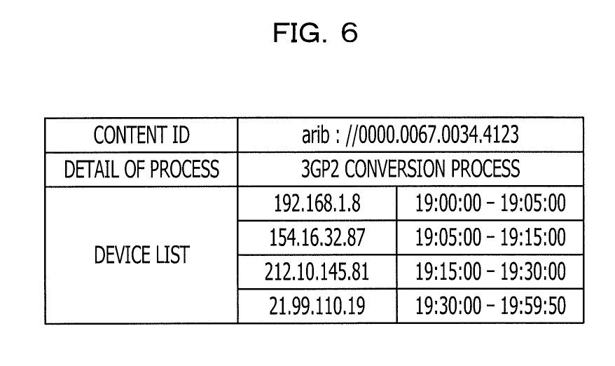

FIG. 6 is an outline diagram illustrating an example of a process assignment table. The process assignment table illustrated in FIG. 6 stores a content ID that is information on the identification of the content data; the detail of a process that is performed by the data processing devices 100; a list of the data processing devices 100 to which the process is assigned; and information on partial data assigned to the data processing devices 100, while the content ID, the detail of the process, the device list and the assigned part information are associated with each other in the process assignment table. In the example illustrated in FIG. 6, the table indicates the data processing devices 100 to which a 3GP2 conversion process that is to be performed on content data “arib://0000.0067.0034.4123” is assigned; and data that is assigned to and processed by the data processing devices 100.

An acquiring unit 204 acquires delivery period information stored in the storage unit 203, compares the delivery period information with the current time, and determines whether or not it is time to perform the assignment process. The delivery period information stored in the storage unit 203 includes a start time of broadcast and an end time of the broadcast, which are related to a time period for delivery of the content data to the data processing devices. When the current time is before the start time of the broadcast, the acquiring unit 204 determines that the current time is before the start of the delivery. When the current time is after the start time of the broadcast and before the end time of the broadcast, the acquiring unit 204 determines that the current time is before the end time of the time period for the delivery. When the current time is after the end time of the broadcast, the acquiring unit 204 determines that the current time is after the end time of the time period for the delivery. When it is time to perform the assignment process as a result of the determination made by the acquiring unit 204, the acquiring unit 204 instructs the second assigning unit 202c to perform the assignment process. An example in which the acquiring unit 204 acquires the delivery period information stored in the storage unit 203 and operates is described above. However, the acquiring unit 204 is not limited to the aforementioned operations. For example, the acquiring unit 204 may receive trigger signals from a delivery server at the start time of the broadcast and the end time of the broadcast and operate using the received trigger signals as triggers. The delivery server delivers content data. In this case, the trigger signals transmitted from the delivery server correspond to the delivery period information on the time period for the delivery.

In the example illustrated in FIG. 6, communication addresses are registered as the information on the identifications of the data processing devices 100, and information on time stamps is registered as the assigned part information. The information on the identifications of the data processing devices 100 may be any information as long as the information can uniquely identify the data processing devices 100. In addition, the assigned part information may be any information as long as the information defines a range of the data to be processed.

The information stored in the process assignment table is not limited to the aforementioned information and may include the time of reception of the assignment request transmitted from each of the data processing devices 100, and throughput information that indicates the throughput of each of the data processing devices 100.

Next, operations that are performed after the process assigning device 200 receives the assignment request are described in further detail. The assignment request processing unit 201 of the process assigning device 200 receives the assignment request from each of the data processing devices 100. The assignment request includes information (the content ID and the detail of the process) on the target content as illustrated in FIG. 3.

When the assignment request processing unit 201, for example, receives the assignment request, the assignment request processing unit 201 notifies the assignment control unit 202 of the information on the target content and the information (for example, communication address) on the identification of the data processing device 100 that has transmitted the assignment request. The determining unit 202a of the assignment control unit 202 searches the process assignment table stored in the storage unit 203 and determines whether or not another data processing device that transmits an assignment request specifying the same content data and the same detail of the process exists.

When the determining unit 202a determines that the data processing device that transmits the assignment request specifying the same content data and the same detail of the process does not exist, the determining unit 202a generates a new process assignment table for the detail of the process and registers, in the new process assignment table, the information on the identification of the data processing device 100 that has transmitted the assignment request. Then, the first assigning unit 202b determines data to be assigned to and processed by the data processing device 100 and registers the assigned part information in the new process assignment table.

The data to be processed, which is assigned to the data processing device 100 by the first assigning unit 202b, may be the entire content data or a specified part (or predetermined part) of the content data.

On the other hand, when the determining unit 202a determines that the other data processing device that transmits the assignment request specifying the same content data and the same detail of the process exists, or when the process assignment table is already generated for the detail of the process, the information on the identification of the data processing device 100 that has transmitted the assignment request is added to the device list of the process assignment table. Then, the second assigning unit 202c determines data to be assigned to and processed by the data processing device 100 that has newly transmitted the assignment request, and the second assigning unit 202c determines data to be assigned to and processed by the other processing device 100 to which data has been already assigned. The updating unit 202d updates the assigned part information of the process assignment table.

The second assigning unit 202c may evenly assign data to be processed to the data processing devices 100. In addition, the second assigning unit 202c may acquire the throughput information from each of the data processing devices 100 and assign data to be processed to the data processing devices 100 on the basis of the throughput information.

When the first assigning unit 202b and the second assigning unit 202c determine the assignments of the data parts to be processed, the assignment control unit 202 notifies the assignment request processing unit 201 of the information on the identifications of the interested data processing devices 100 and the information on the determined assigned parts. Then, the assignment request processing unit 201 transmits the assigned part information and the device list to the interested data processing devices 100.

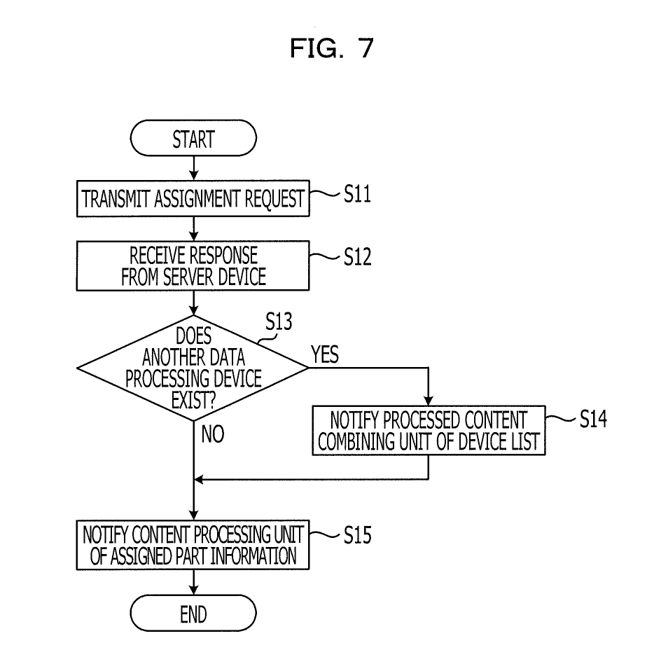

Next, processes that are performed by the process assigning system disclosed herein are described. FIG. 7 is a flowchart of a process that is performed when the data processing device 100 requests an assignment. The data processing device 100 first transmits, to the process assigning device 200, the assignment request that includes the content ID and the detail of the process, and the data processing device 100 requests the process assigning device 200 to assign data to be processed to the interested data processing device 100 (in operation S11). The data processing device 100 waits for a response from the process assigning device 200.

When the server processing unit 102 of the data processing device 100 receives the response from the process assigning device 200 (in operation S12) or receives the assigned part information and the device list that are included in the response from the process assigning device 200, the server processing unit 102 references the device list and determines whether or not another data processing device 100 to which data to be processed is assigned exists (in operation S13).

When the other data processing device 100 to which the data to be processed is assigned exists (Yes in operation S13), the server processing unit 102 notifies the processed content combining unit 105 of the device list (in operation S14) and notifies the content processing unit 103 of the assigned part information (in operation S15).

When the other data processing device 100 to which the data to be processed is assigned does not exist (No in operation S13), the server processing unit 102 notifies the content processing unit 103 of the assigned part information (in operation S15).

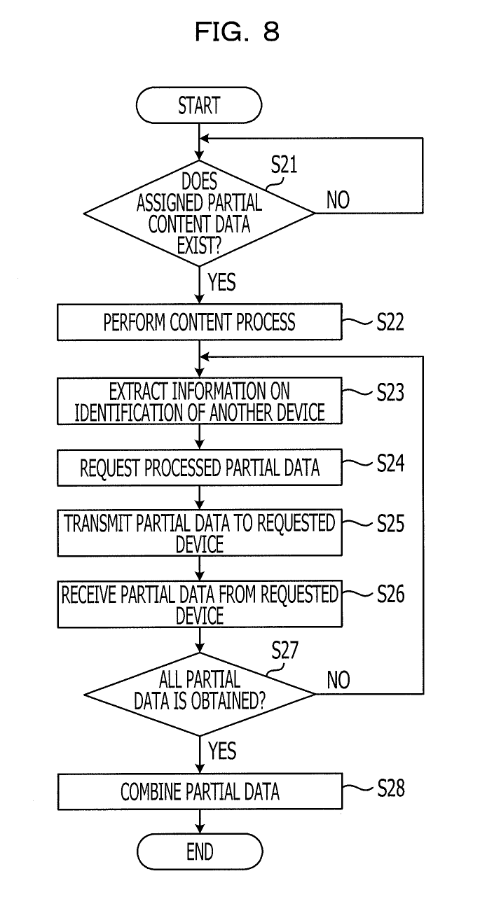

FIG. 8 is a flowchart of the content process that is performed by the data processing device 100. The content processing unit 103 of the data processing device 100 searches the content storage unit 104 and thereby determines whether or not assigned partial content data exists (in operation S21). For example, when the current time is before the start time of delivery of the content data and the assigned partial content data does not exist in the content storage unit 104 (No in operation S21), the content processing unit 103 waits until the content processing unit 103 obtains the assigned partial content data.

When the assigned partial content data exists (Yes in operation S21), the content processing unit 103 performs the content process on the assigned partial content data (in operation S22). The detail of the content process is the process detail of which the data processing device 100 has notified the process assigning device 200 at the time of the request for the assignment. For example, the content process includes a process of converting the format (encoding format) of the content data, a process of increasing a resolution of the content data, a process of improving the image quality of the content data and the like.

In addition, the processed content combining unit 105 extracts the information on the identification of data processing devices other than the own data processing device 100 from the device list transmitted by the server processing unit 102 (in operation S23) and requests the data processing devices corresponding to the extracted identification information to transmit processed partial data (in operation S24). In this case, when the partial data is yet to be completely processed by the requested data processing device 100, the processed content combining unit 105 may change the requested data processing device to another data processing device to be requested and may request the other data processing device to transmit the processed partial data.

Next, the processed content combining unit 105 transmits the partial data processed by the own data processing device 100 to the requested data processing device (in operation S25) and receives the partial data processed by the requested data processing device (in operation S26).

Next, the processed content combining unit 105 determines whether or not to obtain all processed partial data of the entire content (in operation S27). When the processed content combining unit 105 does not obtain at least a part of all the processed partial data (No in operation S27), the process returns to operation S23 so that the own data processing device 100 continues to exchange the processed partial data with at least one of the other data processing devices.

When the processed content combining unit 105 obtains all the processed partial data (Yes in operation S27), the processed content combining unit 105 combines all the processed partial data (in operation S28) to form processed data of the entire content. The formed processed content data is stored in the content storage unit 104.

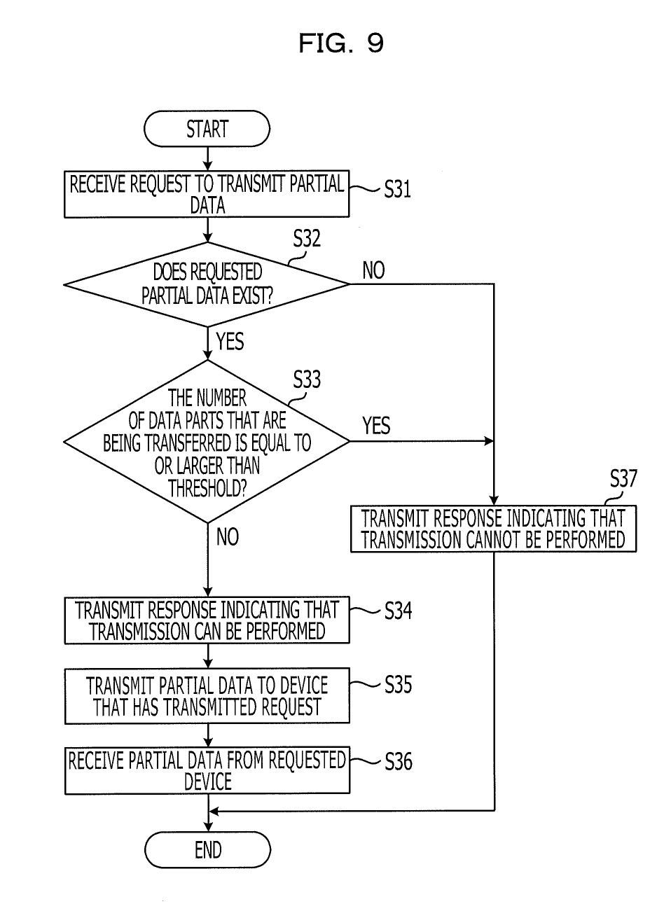

FIG. 9 is a flowchart of a process that is performed when the data processing device 100 receives a request to transmit the partial data from another data processing device. When the data processing device 100 receives a request to transmit the partial data from another data processing device (in operation S31), the data processing device 100 determines whether or not the requested partial data is already processed and exists in the content storage unit 104 (in operation S32).

Then, the data processing device 100 determines whether or not the number of data parts that are being transferred through the processed content combining unit 105 is equal to or larger than a threshold (for example, 2) (in operation S33). When the requested partial data exists in the content storage unit 104 (Yes in operation S32) and the number of data parts that are being transferred through the processed content combining unit 105 is smaller than the threshold (No in operation S33), the data processing device 100 transmits, to the other data processing device, a response that indicates that the processed partial data can be transmitted (in operation S34).

After that, the data processing device 100 transmits the processed partial data to the other data processing device that has transmitted the request to transmit the partial data (in operation S35), and the data processing device 100 receives processed partial data from the other data processing device 100 (in operation S36).

On the other hand, when the data processing device 100 determines that the requested partial data does not exist in the content storage unit 104 (No in operation S32), or when the number of data parts that are being transferred is equal to or larger than the threshold (Yes in operation S33), the data processing device 100 transmits, to the other data processing device 100, a response that indicates that the processed partial data cannot be currently transmitted (in operation S37). In this case, the data processing device 100 notifies the other data processing device 100 of information on the partial data processed by the interested data processing device 100.

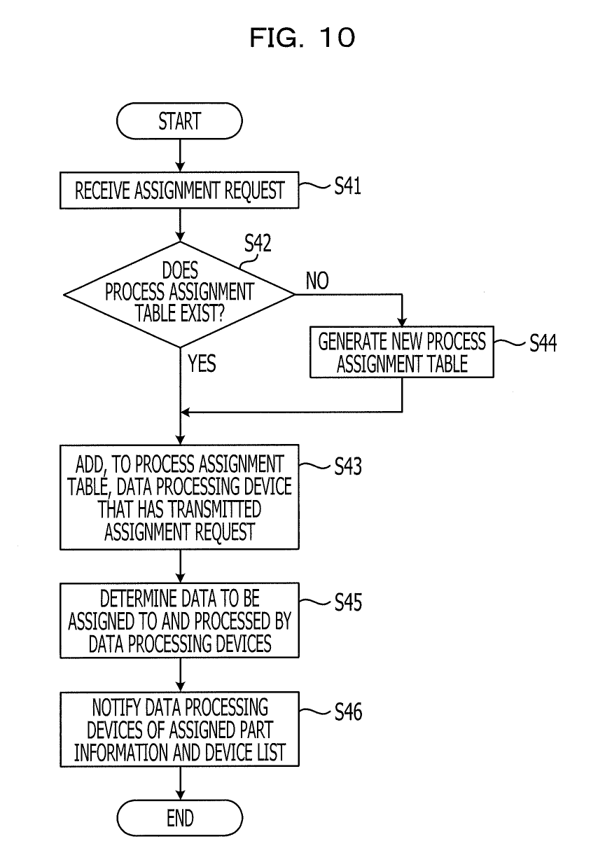

FIG. 10 is a flowchart of a process that is performed by the process assigning device 200. When the process assigning device 200 receives the assignment request from the data processing device 100 (in operation S41), the determining unit 202a of the process assigning device 200 references information stored in the storage unit 203 and thereby determines whether or not a process assignment table in which the same content and the same process detail are registered already exists in the storage unit 203 (in operation S42).

When the process assignment table in which the same content and the same process detail are registered already exists in the storage unit 203 (Yes in operation S42), the data processing device 100 that has transmitted the assignment request is additionally registered in the process assignment table (in operation S43). On the other hand, when the process assignment table does not exist in the storage unit 203 (No in operation S42), a new process assignment table in which the process detail and the content ID that are included in the assignment request are registered is generated (in operation S44). The data processing device that has transmitted the assignment request is registered in the generated new process assignment table (in operation S43).

Then, data to be assigned to and processed by the data processing devices 100 is determined (in operation S45). In this case, when the data is assigned to only the data processing device 100 that has transmitted the assignment request, the first assigning unit 202b assigns the entire content data or a specified part (or predetermined part) of the content data to the data processing device 100. In addition, in order to assign the data to be processed to at least one of the data processing devices and the data processing device 100 that has transmitted the assignment request, a part of the data to be processed is not assigned to a device causing the largest load (or performing a process for a long time) and is assigned to a data processing device 100 that has been newly and additionally registered for the data part.

Then, the assignment request processing unit 201 of the process assigning device 200 notifies the data processing devices 100 to which the data to be processed is assigned of the assigned part information and the device list (in operation S46).

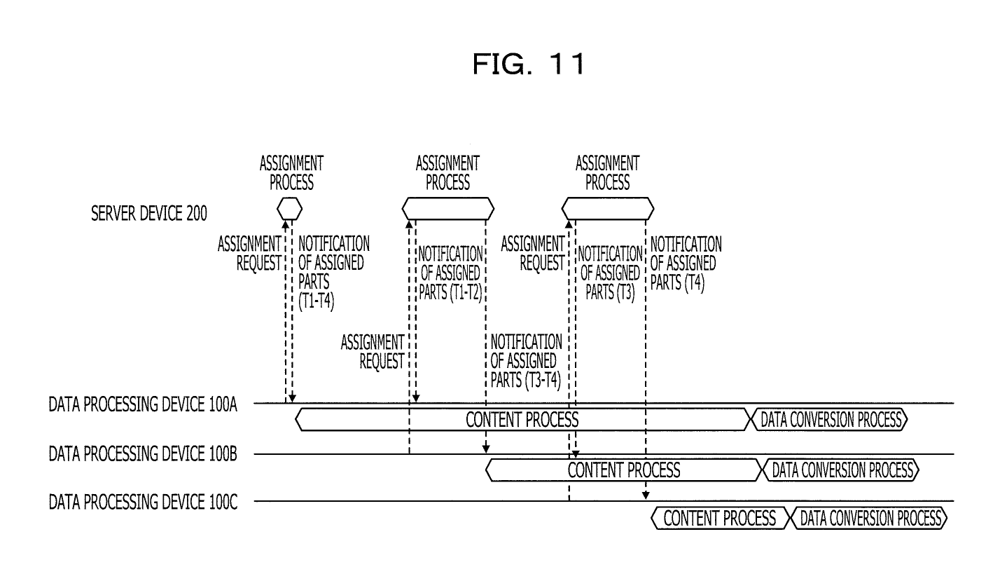

FIG. 11 is a schematic diagram illustrating operational timings of the process assigning device 200. For example, after the data processing device 100A first completely accumulates the content data, the data processing device 100A requests the process assigning device 200 to perform an assignment. Since the process assigning device 200 receives the first assignment request, the process assigning device 200 generates a new assignment request table and assigns, to the data processing device 100A, a process to be performed on the entire content data T1 to T4.

When the process assigning device 200 next receives the assignment request from the data processing device 100B, the server device 200 assigns, to the data processing device 100B, a process to be performed on the content data T3 and T4 that is a part of the content data that is assigned to and processed by the data processing data 100A. In addition, the process assigning device 200 notifies the data processing device 100A that only the content data T1 and T2 is assigned to and processed by the data processing device 100A.

When the process assigning device 200 receives the assignment request from the data processing device 100C, the process assigning device 200 assigns a part of the process indicated in the assignment request table to the data processing device 100C. In this example, the process assigning device 200 assigns, to the data processing device 100C, a part of the process assigned to the data processing device 100B and notifies the data processing device 100B that only the content data T3 is assigned to and processed by the data processing device 100A.

Then, the data processing devices 100A to 100C exchange the processed partial data with each other in order from data subjected to the content process.

In the aforementioned example, when the process assigning device 200 receives the assignment request from the data processing device 100A, the process assigning device 200 immediately returns the response to the assignment request. However, for example, the process assigning device 200 may wait for a certain time after the reception of the first assignment request, assign the data to be processed and return the response after the certain time or when the process assigning device 200 receives a certain number of assignment requests. When the data processing devices 100A to 100C complete the content process on the assigned partial data, the data processing devices 100A to 100C each perform a process of exchanging the partial data with the other devices. When each of the data processing devices 100A to 100C acquires all the processed partial data of the entire content, the data processing device combines the processed partial data and forms the data of the entire content so that the processed content can be used.

When the data processing devices 100A to 100C each complete the content process on the assigned data or every time a certain time elapses, each of the data processing devices 100A to 100C may transmit information that indicates the progress of the content process. In this case, the process assigning device 200 uses the information on the progress of the content process and assigns, to the data processing devices 100A to 100C, data to be processed in the content process.

In an embodiment, the content process and the parts of the content data are assigned so that boundaries of the parts of the content data match each other. For example, in the content process, the data processing device 100 converts the content so that the first video frame of interested partial data and the first audio frame of the interested partial data serve as index frames. In the process of analyzing the content, parts of the content data may be assigned so that parts of the assigned parts overlap each other (for example, a data part of 0:00 to 1:05 and a data part of 1:00 to 2:05 are assigned so that data parts of 1:00 to 1:05 overlap each other) in order to prevent the analysis from being terminated in the middle of a scene.

In an embodiment, when the data processing devices 100 try to perform the same content process, the parts of the process are assigned to the data processing devices 100 so that the partial data is exchanged among the data processing devices 100. Thus, the process is jointly performed by the data processing devices 100 in a manner in which all the data processing devices 100 each have an advantage, and it is possible to improve the efficiency of the process.

For example, when ten devices try to perform the same content process, each of the devices processes a part of the entire content using a tenth of the original resources for a tenth of the original time period on average. Since the time period for the content process and the amount of data to be processed can be reduced, it becomes easy to add a function by performing a software process even in a device that is not a high-end device that has hardware dedicated to the content process, for example.

When a time zone in which a content needs to be used varies, each of the data processing devices may notify the server device of the detail of the process at the time of setting of scheduled recording of the content data.

In an embodiment, each of the data processing devices 100 notifies the sever device 200 at the time of setting of scheduled recording of content data that the data processing device 100 performs the content process, and the data processing device 100 requests exchange of processed partial data.

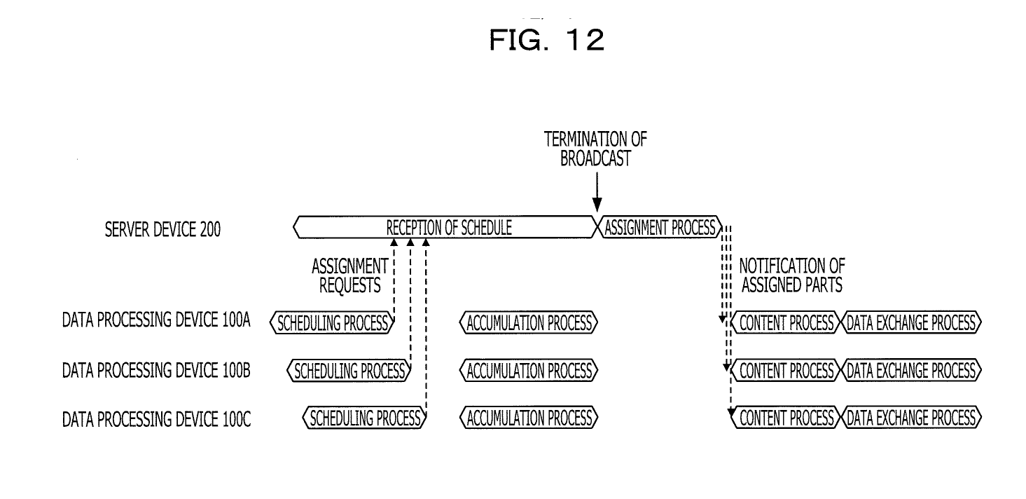

FIG. 12 is a schematic diagram illustrating operational timings of each of the devices. The data processing devices 100 each notify the server device 200 that the data processing device 100 performs the content process before completion of broadcast (or before end of delivery of content data). The data processing devices 100 each perform a process of recording content data during the broadcast.

The process assigning device 200 only receives the assignment requests from the data processing devices 100 until broadcast of a single content is ended. After the broadcast is ended, the process assigning device 200 determines data to be assigned to and processed by the data processing devices 100 registered in the device list and transmits the assigned part information and the device list to the data processing devices 100. The data to be processed may be evenly assigned to the data processing devices 100. In addition, the data to be processed may be assigned to the data processing devices 100 so that the amount of the assigned data varies depending on the throughput of the data processing device 100.

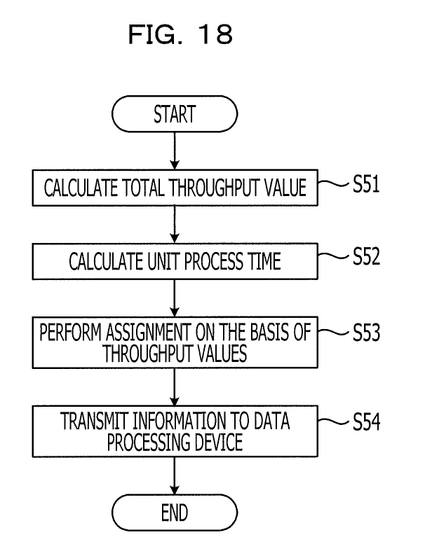

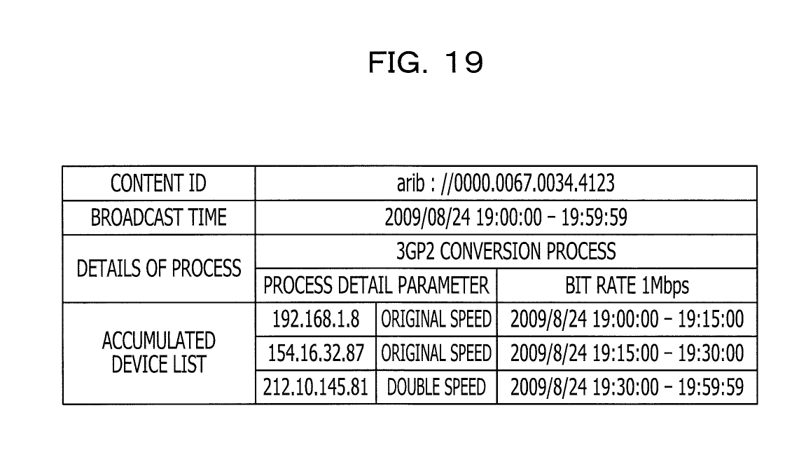

FIG. 18 is a flowchart of a process that is performed by the second assigning unit. FIG. 19 is a diagram illustrating an example of a process assignment table when an amount of assigned data varies depending on the throughput of the data processing device. The process assignment table illustrated in FIG. 19 includes the detail of the process and a process detail parameter and is provided for the data processing devices 100 that indicate the same process detail and the same process detail parameter.

When the process assigning device 200 receives, from the data processing device 100, an assignment request that includes a throughput value, the process assigning device 200 references a process assignment table including the same content ID and the same details of the process. Then, the process assigning device 200 adds information on the identification of the data processing device 100 that has requested the assignment, and the process assigning device 200 adds the throughput value of the data processing device 100 that has requested the assignment.

When the second assigning unit 202c is instructed by the acquiring unit 204 to perform the assignment process, the second assigning unit 202c performs the process illustrated in FIG. 18. The second assigning unit 202c references the process assignment table that includes the same content ID and the same details of the process. Then, the second assigning unit 202c reads throughput values of all the data processing devices 100 registered in the process assignment table. The second assigning unit 202c calculates, on the basis of the read throughput values, the total throughput value of the data processing devices 100 registered in the process assignment table (in operation S51). For example, the second assigning unit 202c calculates 1+1+2=4, which is the total throughput value. The second assigning unit 202c reads a broadcast time from the process assignment table, and calculates, on the basis of a time period (for performing the process) defined by the read broadcast time and the calculated total throughput value, a unit process time that is a time period for which the process is performed per unit throughput (in operation S52). For example, the second assigning unit 202c calculates 59 minutes 59 seconds/4=900 seconds that are the unit process time.

The second assigning unit 202c assigns, on the basis of the calculated unit process time and the throughput values of the data processing devices, parts to be processed by the data processing devices, and writes the assignment results in the process assignment table (in operation S53). The second assigning unit 202c notifies the assignment request processing unit 201 of the information on the identifications of the interested data processing devices 100 and the information on the determined assigned parts (in operation S54). The assignment request processing unit 201 transmits the assigned part information and the device list to the interested data processing devices 100 as described above. While a specific value (throughput value) is described herein, the present invention is not limited to distributing or assigning executing of a process based on any particular value or parameter. For example, a process parameter or value relative to any condition may be specified and registered in the process assignment table.

The assigned part information and the device list may be transmitted at the start time of the broadcast. In addition, the assigned part information and the device list may be transmitted to each of the data processing devices every time the assignment request processing unit 201 receives the assignment request from the data processing device 100.

The process assigning device 200 determines partial data to be assigned to the data processing devices 100 at the end time of broadcast and notifies the data processing devices 100 of the assigned partial data. Each of the data processing devices 100 performs the content process on the assigned partial data. Then, the data processing devices 100 each perform the process of exchanging the processed partial data with the other devices in the same manner as the above described embodiment so as to acquire the processed partial data from the other devices. After the data processing device 100 acquires all the processed partial data of the entire content, the data processing device 100 combines the processed partial data and forms the processed data of the entire content.

In an embodiment, the process assigning device 200 determines the data to be assigned to and processed by the data processing devices 100 at the end time of the broadcast. However, the process assigning device 200 may determine the data to be assigned to and processed by the data processing devices at the start time of the broadcast.

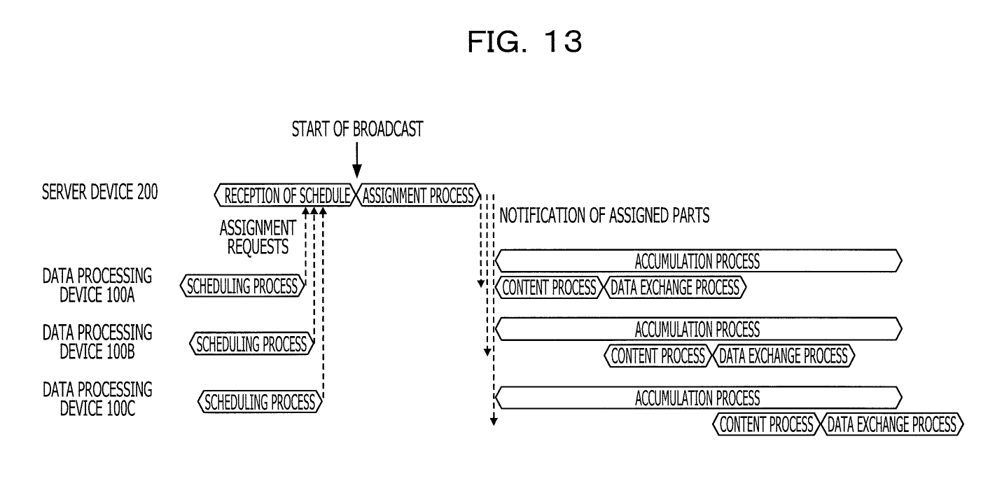

FIG. 13 is a schematic diagram illustrating operational timings of each of the devices according to an embodiment. In an embodiment, the data processing devices 100 each perform the content process on partial content data assigned to the device at the time of completion of reception and storage of the data while performing a process of storing content data. After the assigned partial data is completely processed, the data processing devices 100 each perform the process of exchanging the processed partial data.

In an embodiment, when the data processing device 100 can receive the assigned partial data during storage of content data, the data processing device 100 can start performing the content process. Thus, the data processing device 100 has an advantage compared with an embodiment.

In the above described embodiments, the process assigning device 200 transmits the assigned part information and the device list to the data processing devices 100 at a certain time. However, every time the process assigning device 200 receives the assignment request from each of the data processing devices 100, the process assigning device 200 may reassign data to be processed to the data processing devices 100 and notify the data processing devices 100 of the assigned data to be processed.

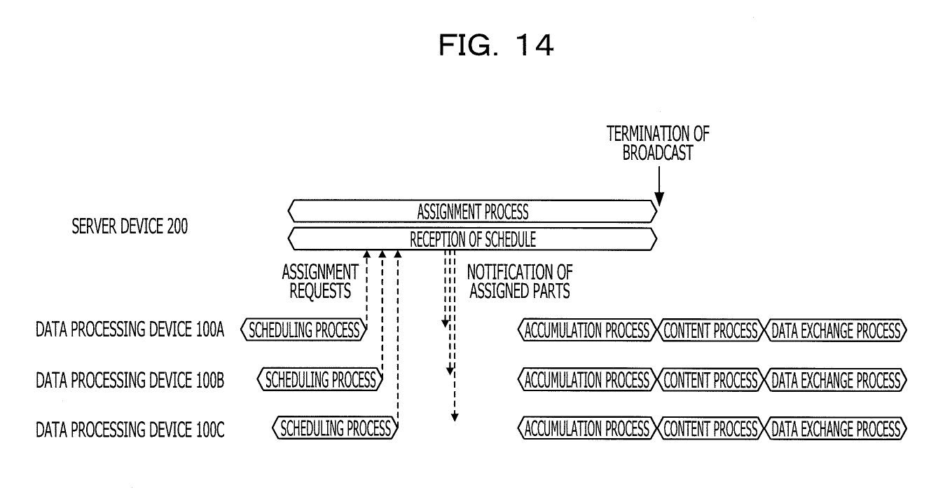

FIG. 14 is a schematic diagram illustrating operational timings of each of the devices according to an embodiment. In an embodiment, every time the process assigning device 200 receives the assignment request from each of the data processing devices 100, the process assigning device 200 determines partial data to be assigned to the data processing devices 100 and notifies the data processing devices 100 of the assigned part information and the device list.

Then, the data processing devices 100 each perform the content process on the assigned data at the time of completion of the broadcast. The data processing devices 100 each perform the process of exchanging the processed partial data with the other data processing devices so as to acquire the processed partial data from the other data processing devices. When the data processing device 100 acquires all the processed partial data of the entire content, the data processing device 100 combines all the processed partial data and forms the processed data of the entire content.

In an embodiment, although the communication volume increases, there is an advantage that it is not necessary to maintain communication sessions between the process assigning device 200 and the data processing devices 100.

In an embodiment, a configuration in which a license is managed in a similar manner to a broadcast content is described.

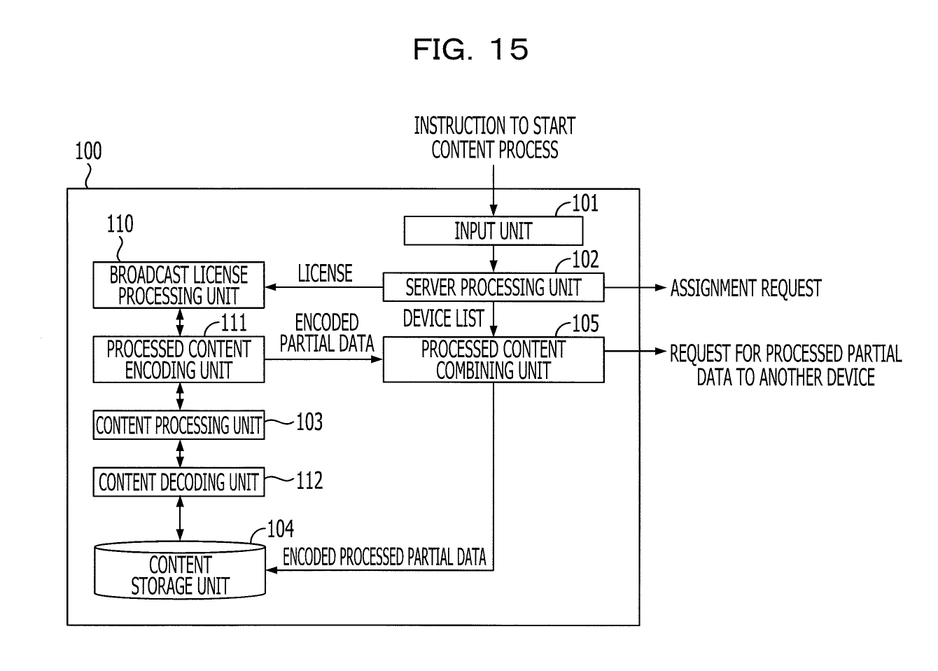

FIG. 15 is a block diagram illustrating an internal configuration of a data processing device 100 that has a function of managing a license. The data processing device 100 according to an embodiment includes the input unit 101, the server processing unit 102, the content processing unit 103, the content storage unit 104 and the processed content combining unit 105, which are described in at least one of the above described embodiments. In addition, the data processing device 100 according to an embodiment includes a broadcast license processing unit 110, a processed content encoding unit 111 and a content decoding unit 112.

The data processing device 100 according to an embodiment is instructed by a scheduler or by receiving user input to request an assignment in the same manner as the above described embodiment. The server processing unit 102 that receives the instruction to request the assignment transmits the assignment request to the process assigning device 200.

When the server processing unit 102 receives a response to the assignment request from the server device 200, the server processing unit 102 transfers, to the broadcast license processing unit 110, license information that indicates a license and is included in the response transmitted by the process assigning device 200.

In addition, the server processing unit 102 notifies the processed content combining unit 105 of the device list included in the response and transfers the assigned part information included in the response to the content processing unit 103 so as to instruct the content processing unit 103 to start the content process.

The content processing unit 103 performs the content process on the partial data according to the received assigned part information. Then, the content processing unit 103 transmits the processed partial data to the processed content encoding unit 111. The processed content encoding unit 111 encodes the processed partial data using a content key that is included in the license.

After that, the processed content encoding unit 111 transmits the encoded processed partial data to the processed content combining unit 105. The processed content combining unit 105 exchanges the encoded processed partial data with the other data processing devices. The encoded processed partial data that is acquired from the other processing devices is stored in the content storage unit 104 without a change in the data.

The encoded partial data that is stored in the content storage unit 104 is decoded by the content decoding unit 112 in a similar manner to a broadcast license. The decoded processed partial data may be used for generation of tag information or chapter information during reproduction at a local site. In addition, the converted content may be re-encoded for an external device (e.g., mobile phone) and stored in a portable recording medium so that the content can be carried outside. While management of a license is described herein relative to content processing, updating and exchanging (or other processing) of content described herein may be based on other types of verifications including but not limited to user or machine rights, subscription, etc.

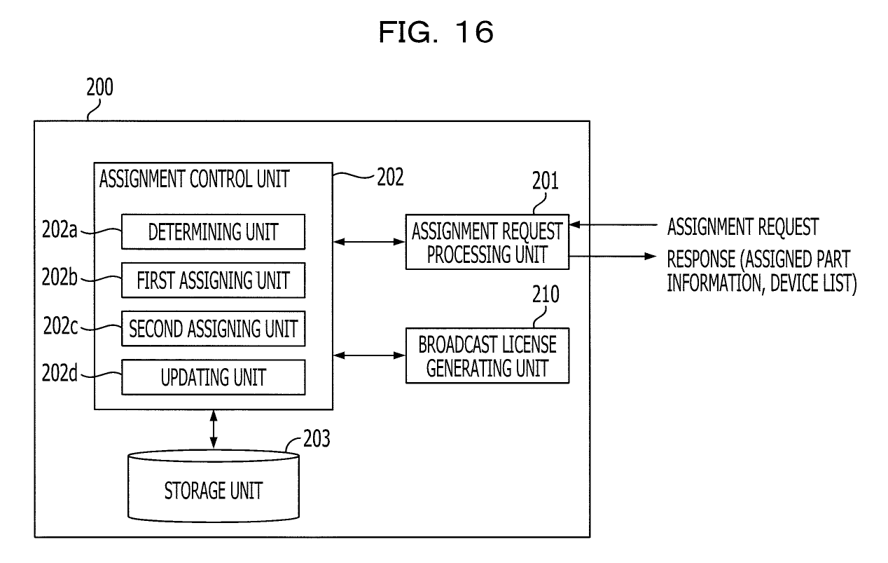

FIG. 16 is a block diagram illustrating an internal configuration of a process assigning device 200 that has a function of managing a license. The process assigning device 200 according to an embodiment includes the assignment request processing unit 201, the assignment control unit 202 and the storage unit 203, which are described in the above identified embodiment. In addition, the process assigning device 200 according to an embodiment includes a broadcast license generating unit 210.

The process assigning device 200 according to an embodiment receives the assignment requests from the data processing devices 100 and performs the process of assigning data parts to the data processing devices 100 on the basis of the process assignment table in the same manner as the above described embodiment. Then, the process assigning device 200 generates a content key and a license, which are used for data exchange and provided for the data processing devices 100 to which the same content and same details of the process have been assigned. The content key is included in the license and encoded so that the content key cannot be decoded by a device that cannot process a broadcast license. Then, the process assigning device 200 transmits the assigned part information, the device list and the license information to the data processing devices 100.

In an embodiment, since the processed content data is managed in the same manner as a broadcast license, it is possible to protect the processed content data with a similar security level to a broadcast content. As a standard for the aforementioned license, a Marlin license and the like are known, for example.

According to an embodiment a method of assigning a process is provided where the method includes receiving an assignment request and returning partial data of content to be processed and a list of devices to which respective parts of the content is assigned, associating each of the respective parts of the content assigned with a corresponding identifier of a destination based on the list and exchanging processed respective parts of the content among the devices in the list.

The programs described in the embodiments are stored in a computer-readable storage medium and delivered. Examples of the computer-readable storage medium are a flexible disk, a hard disk, a compact disc-read only memory (CD-ROM), a DVD-ROM, a DVD-random access memory (DVD-RAM), a Blu-Ray® disc (BD), a USB memory, and another nonvolatile memory such as a flash memory.

The computer programs may be transmitted through at least one of digital communication using a broadcast wave, an electric communication line, a wireless or cable communication line, a network represented by the Internet and the like. However, the examples of the computer-readable storage medium do not include a carrier wave that includes the computer programs. Even if the computer programs are included in a carrier wave and carried by the carrier wave, a computer that is a transmission source of the programs has a readable storage medium. Thus, the computer-readable storage medium is a physically tangible storage medium.

The broadcast wave may be a ground wave or a satellite broadcast wave or may be transmitted through a network for cable television. The cable television may modulate a carrier wave into light and use an optical fiber as a transmission medium. The computer-readable storage medium is a physically tangible storage medium regardless of the type of the transmission medium of the carrier wave.

Accordingly, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. A process assigning device, comprising:
a storage unit that stores process assignment table includes content identification information identifying content data, process identification information identifying a type of a process of processing the content data, device identification information identifying a data processing device that processes the content data, assigned part information indicating a part included in the content data and assigned to and processed by the data processing device; and
a processor that performs an operation including:
receiving an assignment request from the data processing device processing the content data, the assignment request including the device identification information, the content identification information and the process identification information,
checking whether identification information of another device which process the same content data and same process indicated by the assignment request exists in the storage unit,
wherein when the other data processing device to which process the same content data and same process indicated by the assignment request does not exist in the storage, the processor assigns the device to process all of the content, and generates a new process assignment table which includes the device identification information and the content identification information and the process identification information included in the assignment request, and stores the new process assignment table to the storage unit, and
when the other data processing device to which process the same content data and same process indicated by the assignment request exists, the processor assigns the device to process part of the content, and update the process assignment table in the storage, and
wherein the processor transmits the assigned part information to the data processing device identified by the device identification information stored.

2. The process assigning device according to claim 1, wherein the processor acquires delivery period information on a time period for delivery of the content data to the data processing device and determines data to be assigned to and processed by the data processing device based on the assignment request received before a start time of the delivery, the start time being indicated in the delivery period information.

3. The process assigning device according to claim 1, wherein the processor acquires delivery period information on a time period for delivery of the content data to the data processing devices and determines, after an end time of the time period for the delivery, data to be assigned to and processed by the data processing devices based on the assignment request received until the end time of the time period of the delivery, the end time being indicated in the delivery period information.

4. The process assigning device according to claim 1, wherein the processor acquires delivery period information on a time period for delivery of the content data to the data processing devices and determines data to be assigned to and processed by the data processing devices when the processor receives the assignment request before an end time of the time period of the delivery, the end time being indicated in the delivery period information.

5. The process assigning device according to claim 1, wherein the storage unit stores throughput information on a throughput of each of the data processing devices, and
wherein the processor determines data to be assigned to and processed by the data processing devices so that an amount of the assigned data varies according to the throughput information stored in the storage unit.

6. A process assigning method, comprising:
receiving an assignment request from a data processing device that processes a content data, the assignment request including the identification information identifying the data processing device and the content identification information and the process identification information;
determining data to be assigned to and processed by the data processing device based on the received assignment request;
transmitting, to the data processing device, the assigned part information that indicates the determined data;
storing the transmitted assigned part information and associating the assigned part information with the identification information indicating the data processing device that has transmitted the assignment request;
checking, based on the information stored, whether another data processing device to which data to be processed is already assigned for the content data that is to be processed and is indicated by a newly received assignment request exists, and
wherein when the other data processing device to which process the same content data and same process does not exist, assigning all content data to be processed to the data processing device that has transmitted the assignment request so that the data processing device that has transmitted the assignment request processes all of the content data; and
when the other data processing device to which process the same content data and same process exists, assigning data to be processed to the data processing devices so that the data processing device that has transmitted the assignment request processes a part of the content data and that the other processing device processes another part of the content data, and updating the information stored.

7. A computer-readable storage medium that stores a computer program that causes a computer to perform an operation, comprising:
determining data to be assigned to a data processing device based on information on the identification of the data processing device and an assignment request that includes a request for assigned part information that indicates a part that is included in content data and assigned to be processed by the data processing device, the identification information and the assignment request being acquired from the data processing device that performs a process on a part or all of the content data;
transmitting, to the data processing device, the assigned part information that indicates the determined data to be processed;
storing the transmitted assigned part information and associating the assigned part information with the information on the identification of the data processing device to which the assigned part information is transmitted;
determining, based on the information stored, whether another data processing device to which data to be processed is assigned for the content data that is to be processed and is indicated by a newly received assignment request exists, and
when the determining indicates that the other data processing device to which the data to be processed is already assigned does not exist, assigning all of the data to be processed to the data processing device that has transmitted the assignment request so that the data processing device that has transmitted the assignment request processes all of the content data;
when the determining indicates that the other data processing device to which the data to be processed is already assigned exists, assigning data to be processed to the data processing devices so that the data processing device that has transmitted the assignment request processes a part of the content data and that the other processing device processes another part of the content data, and updating the information stored.

8. A process assigning device, comprising:
receiving means for receiving identification information and an assignment request from a data processing device that performs a process on a part or all of content data, the assignment request including the device identification information, the content identification information and the process identification information;
assignment control means for determining data to be assigned to the data processing devices based on the assignment request received by the receiving means and transmitting the assigned part information to the data processing devices; and
storage means for storing process assignment tables which stores assigned part information for each contents and processes,
wherein the assignment control means includes:
determining means for determining, based on the information stored in the storing means, whether another data processing device to which processing same content and same process that is indicated by the assignment request received by the receiving means exists;
first assigning means for assigning data to be processed to the data processing device that has transmitted the assignment request so that the data processing device that has transmitted the assignment request processes a part or all of the content data when the determining means determines that the other data processing device to which the data to be processed is already assigned does not exist;
second assigning means for assigning data to be processed to the data processing devices so that the data processing device that has transmitted the assignment request processes a part of the content data and that the other processing device processes another part of the content data when the determining means determines that the other data processing device to which the data to be processed is already assigned exists; and
updating means for updating the information stored in the storing means based on the results of the assignments performed by the second assigning means.

9. The process assigning device according to claim 8, comprising:
acquiring means for acquiring delivery period information on a time period for delivery of the content data to the data processing devices, and
wherein the assignment control means determines data to be assigned to and processed by the data processing devices based on assignment requests received from the data processing devices before a start time of the delivery.

10. The process assigning device according to claim 8, comprising:
acquiring means for acquiring delivery period information on a time period for delivery of the content data to the data processing devices, and
wherein after an end time of the time period for the delivery, the assignment control means determines data to be assigned to and processed by the data processing devices based on assignment requests received until the end time of the time period for the delivery.

11. A method of assigning a process, comprising:
receiving an assignment request and returning partial data of content to be processed and a list of devices to which respective parts of the content is assigned;
associating each of the respective parts of the content assigned with a corresponding identifier of a destination based on the list; and
exchanging processed respective parts of the content among the devices in the list.
